(19) United States
(12) Patent Application Publication
(10) Pub. No.: US 2014/0352561 A1
(43) Pub. Date: Dec. 4, 2014

(54) PROCESS AND APPARATUS FOR CONVERSION OF A COLDSET WEB PRINTING PRESS TO A HYBRID HEATSET AND COLDSET PRINTING PRESS

(71) Applicant: Joe I.V. Rosenberg, Denver, CO (US)

(72) Inventor: Joe I.V. Rosenberg, Denver, CO (US)

(21) Appl. No.: 14/294,124

(22) Filed: Jun. 2, 2014

Related U.S. Application Data
(60) Provisional application No. 61/830,002, filed on May 31, 2013.

(51) Int. Cl. B41F 17/00; B41F 23/04

(52) U.S. Cl. CPC B41F 17/00; B41F 23/0436; B41F 23/0479
USPC 101/178

(57) ABSTRACT

A process and apparatus for converting a coldset printing press to a hybrid heatset and coldset printing press that comprises a infrared heater with a footprint of only about 5 square feet, and optionally an electrical VOC incinerator of about the same size. The hybrid heatset and coldset printing press does not need to make any blanket changes, roller changes, or ink changes when switching between heatset and coldset printing; only the paper is changed.

### CROSS-REFERENCE TO RELATED APPLICATION

This document is a non-provisional patent application claiming priority to, and the benefit of, U.S. Provisional Patent Application Ser. No. 61/830,002; filed May 31 2013, also entitled “Process and Apparatus for Conversion of a Coldset Web Printing Press to a hybrid Heatset and Coldset Printing Press,” which is herein incorporated by reference in its entirety for all purposes.

### BACKGROUND OF THE INVENTION

1. Field of the Invention

The present invention is in the technical field of printing presses. More particularly, the present invention pertains to the field of converting coldset web printing presses to hybrid heatset and coldset web printing presses.

2. Description of Related Art

The coldset web offset printing industry has experienced many changes over the last decade and those commercial printers who continue to redefine their products and expand their markets increase their chances of enduring and surviving. Large daily newspapers have been increasingly converted to commercial printing. In doing so many have installed large and expensive high-end press equipment, or UV equipment, that allow them to print on the glossy paper you find in magazines and newspaper inserts.

Worldwide there has been a propensity to produce higher quality products at lower prices. This has been particularly true in the web offset printing industry. Due to this highly competitive market commercial printers find it necessary and difficult to expand the volume of their sales and reach new markets. Within the existing coldset web offset printing presses in the industry, there is a need for a web drying system that delivers the capability to compete for the demand for the more expensive mid to lower end heatset quality printing on glossy and ground wood products without requiring the purchase of large and expensive gas-fueled ovens (30′-40′ long) used for drying the ink in traditional heatset printing presses; without switching inks or making press adjustments, which consume valuable time; and without using the special inks required to be used with UV printing presses, which are more expensive and would require a cleaning of the press to exchange inks in order to then perform coldset printing which makes it financial non-feasible to switch between printing with heatset or UV inks and dryers and printing with coldset ink.

Descriptions of the invention embodied below allow the cheaper, widely prevalent, and under utilized coldset web offset press equipment found cheaply and abundantly on account of the invention of the internet a dwindling printing industry to economically print both coldset and heatset web offset printing without the need to change inks and without the need for large drying units. With the use of the equipment described herein the traditional coldset printer will be able to compete with high quality heatset and UV printers for customers desiring a glossy heatset type product at a fraction of the capital cost necessary to own a heatset or UV printing press. Additionally, this new hybrid system has an electrically powered dryer with a footprint of only about 5 square feet, and a electrical VOC incinerator of only about 5 square feet that can readily be installed on existing coldset press lines, whereas traditional heatset printing presses have gas powered dryers that are often ten feet high and 30 feet long and require additional large gas powered equipment for remediation of toxic emissions.

### SUMMARY

The scope of the present invention is defined solely by the detailed description of the embodiments thereof and appended claims, and is not affected to any degree by the statements within this summary. In addressing many of the problems experienced in the related art, such as those relating to coldset, heatset, and UV printing presses; the present disclosure generally involves process and apparatus for converting a coldset printing press to a hybrid heatset and coldset printing press.

A combination of systems and a central controller allow coldset printing presses to be converted to produce mixed web and heatset printing with surprising ease, creating a hybrid printing press capable of printing hybrid products quickly and efficiently. This hybrid ability allows the operator of the press to print on newspaper and gloss enamel paper with the same press and same ink at an affordable price. No changes are required on the press line except for the change of paper stock: no retrofitting is required; there are no blanket changes; no roller changes; and no ink changes involved. Once the apparatus has been installed on a coldset printing press, the hybrid printing press can deliver heatset jobs on the coldset printing press without the need for an additional heatset press. The hybrid press drying unit only requires a space as small as 5′×5′ area on, above, or to the side of the press. Likewise the electrical VOC incinerator also requires only an area as small as 5′×5′.

The straight web path may pass through a preconditioner before heading to the main IR assembly, then it may be cooled with a chill roller assembly and/or a former board air cooler; all of which may be integrated through software operating on a central controller allowing the drying of a product with minimal space requirements and minimized environmental impact. Compact and totally merged with the press, the system can replace the large and expensive dryers, chillers, and VOC incinerators typically used with heatset printers.

These and other objectives and advantages of embodiments of the invention will become apparent from the following description taken in conjunction with the accompanying drawings wherein are set forth, by way of illustration and example, certain embodiments of the embodiments of the invention. The drawings are intended to constitute a part of this specification and include exemplary embodiments of the present invention and illustrate various objects and features thereof.

### BRIEF DESCRIPTION OF THE DRAWINGS

The above, and other, aspects, features, and advantages of several embodiments of the present disclosure will be more apparent from the following Detailed Description as presented in conjunction with the following several figures of the Drawing.

### 1. Figures

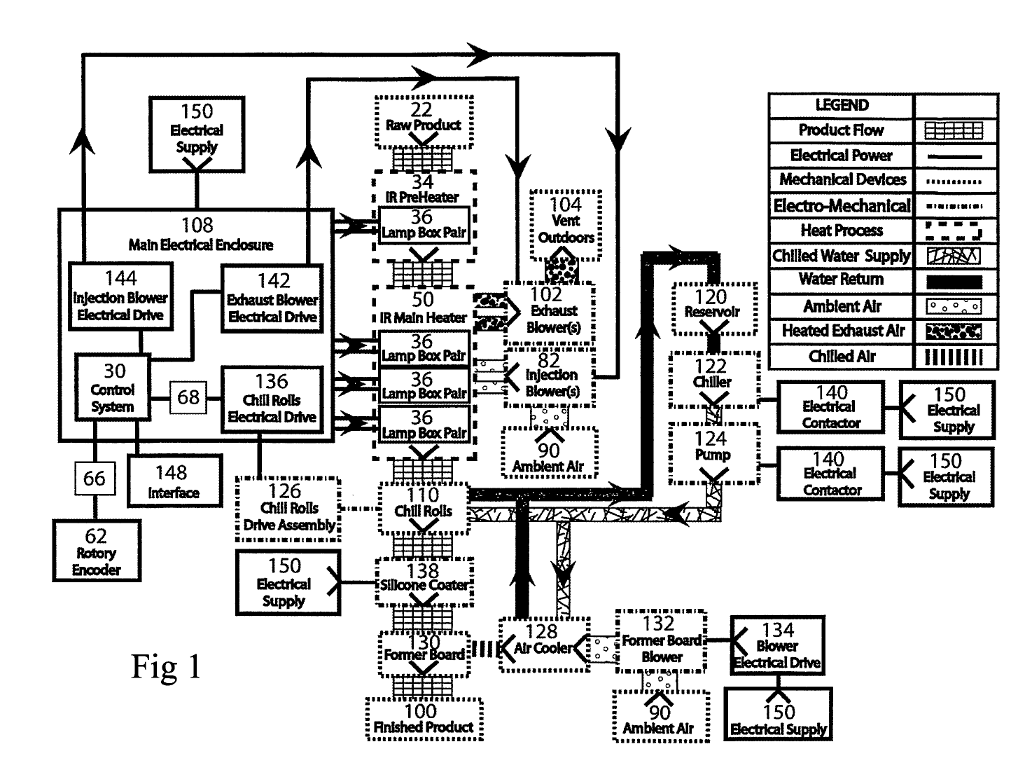

FIG. 1 (Sheet 1) illustrates a process flow chart for a control system for the hybrid system, in accordance with an embodiment of the present disclosure.

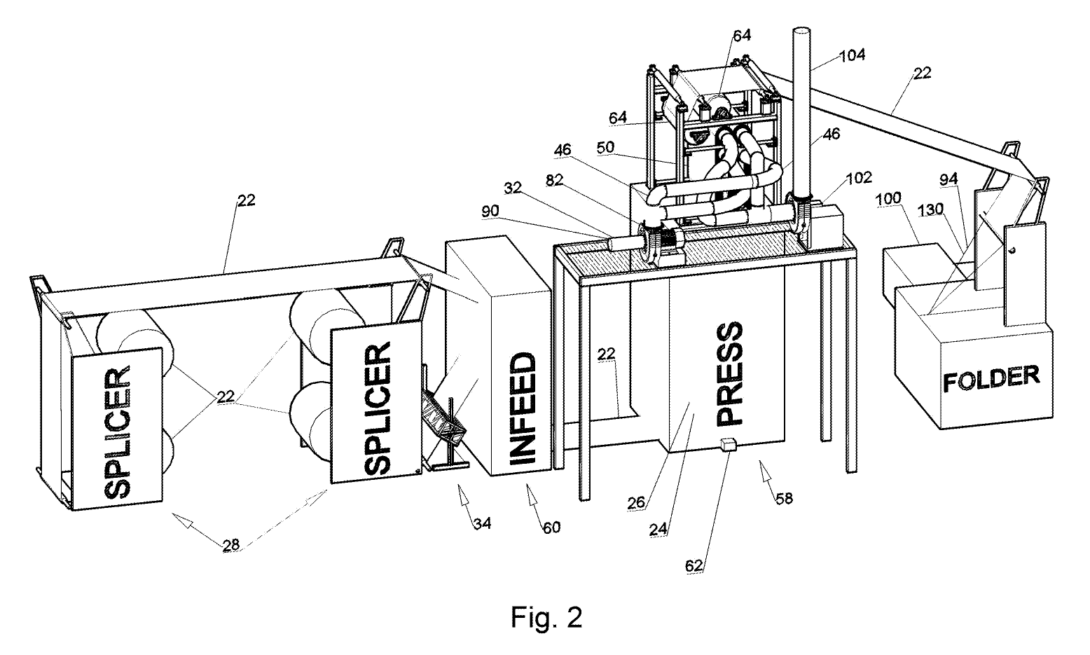

FIG. 2 (Sheet 2) illustrates a perspective view of components of the hybrid system, in accordance with an embodiment of the present disclosure.

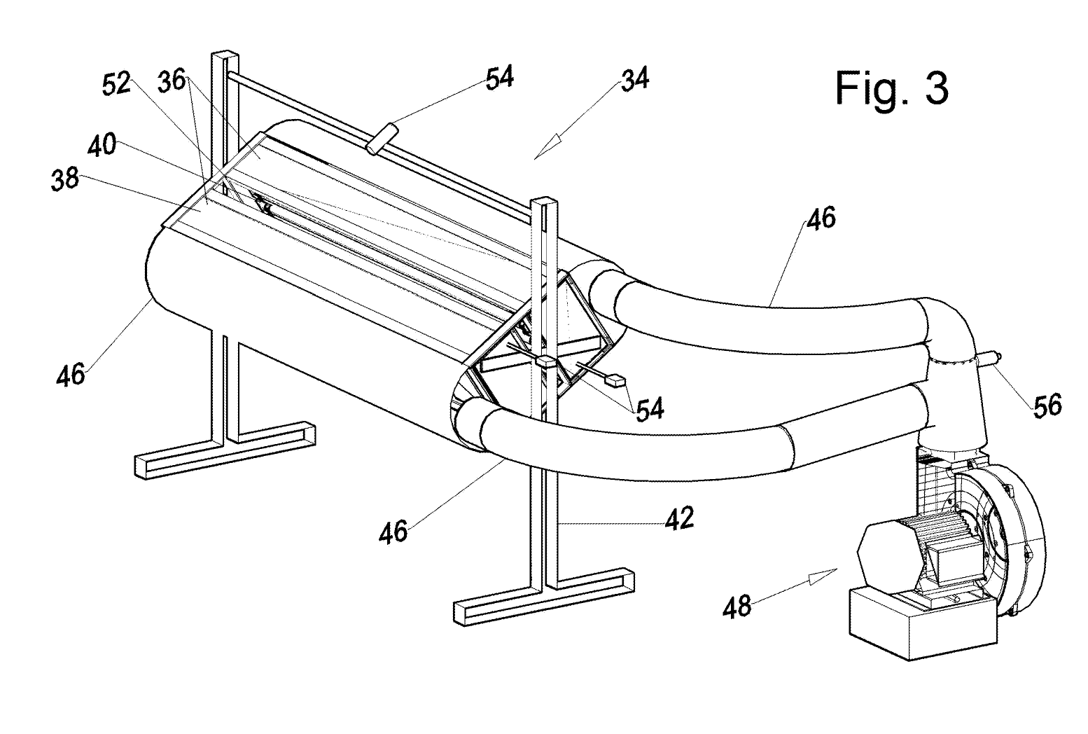

FIG. 3 (Sheet 3) illustrates a preconditioner, in accordance with an embodiment of the present disclosure.

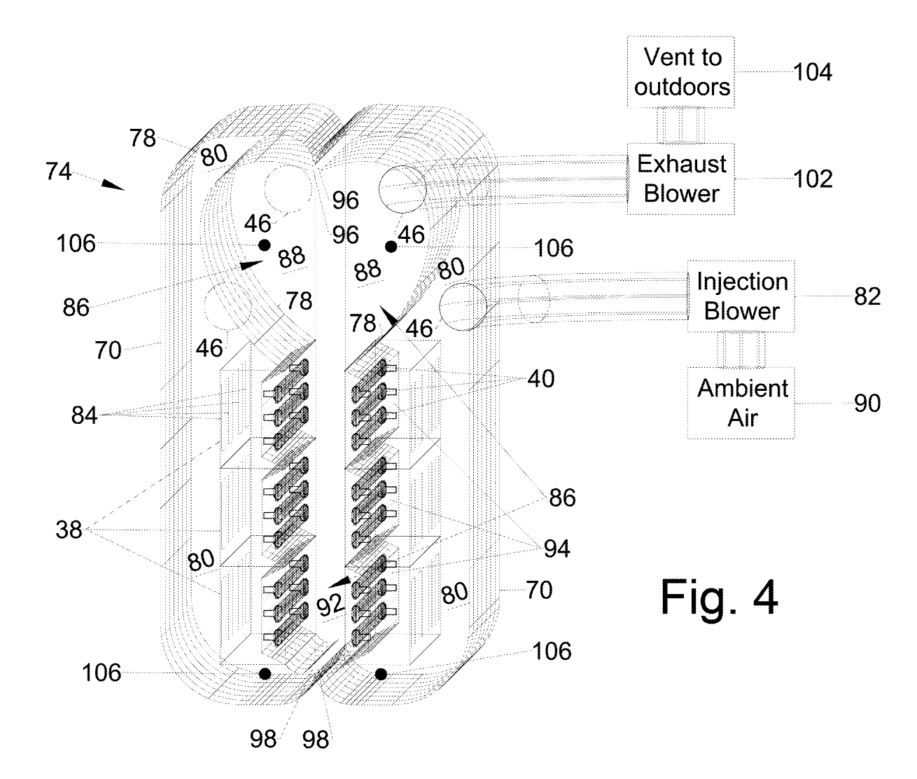

FIG. 4 (Sheet 4) illustrates a skeletal view of the interior of an IR assembly, in accordance with an embodiment of the present disclosure.

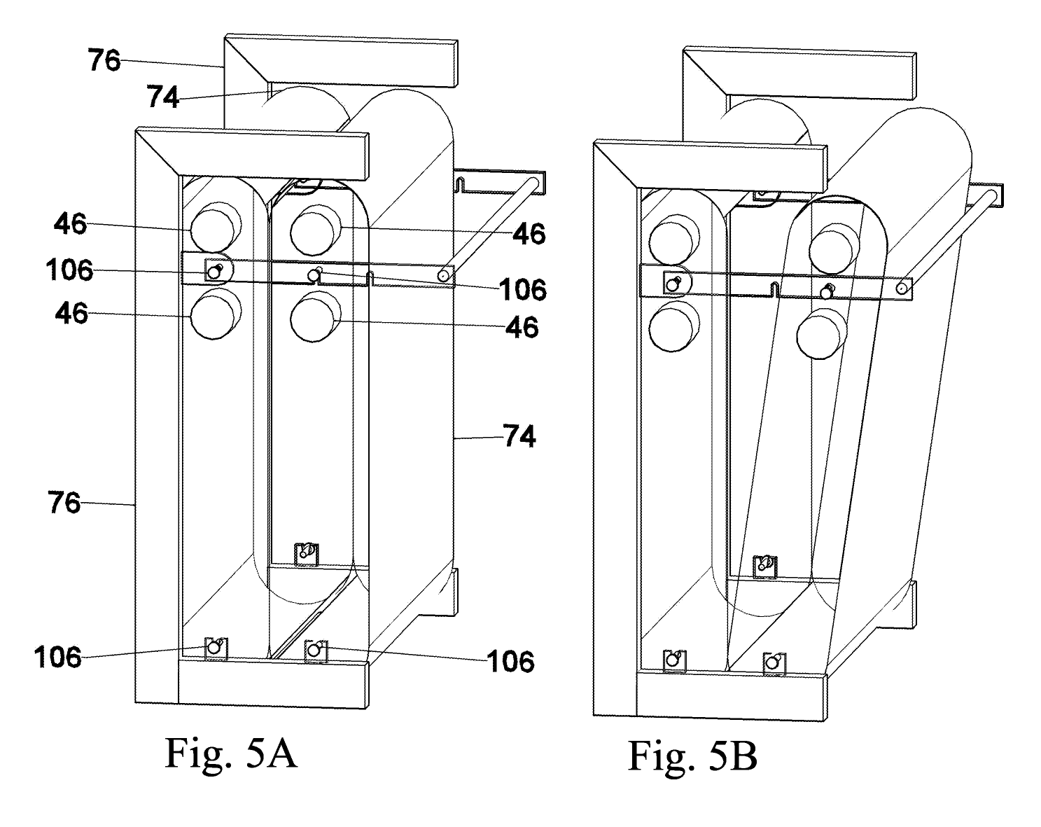

FIG. 5A (Sheet 5) illustrates a perspective view of the IR assembly, in accordance with an embodiment of the present disclosure.

FIG. 5B (Sheet 5) illustrates a perspective view of the same IR assembly as in FIG. 5A in an open position, in accordance with an embodiment of the present disclosure.

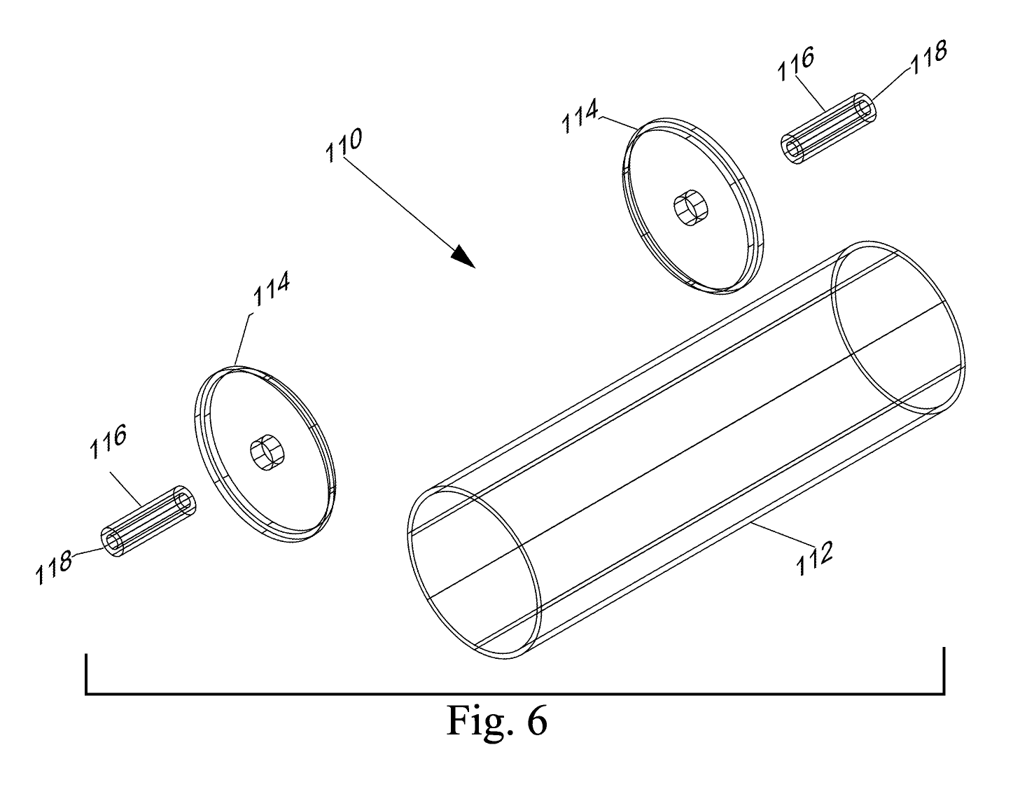

FIG. 6 (Sheet 6) illustrates an exploded view of a chill roll, in accordance with an embodiment of the present disclosure.

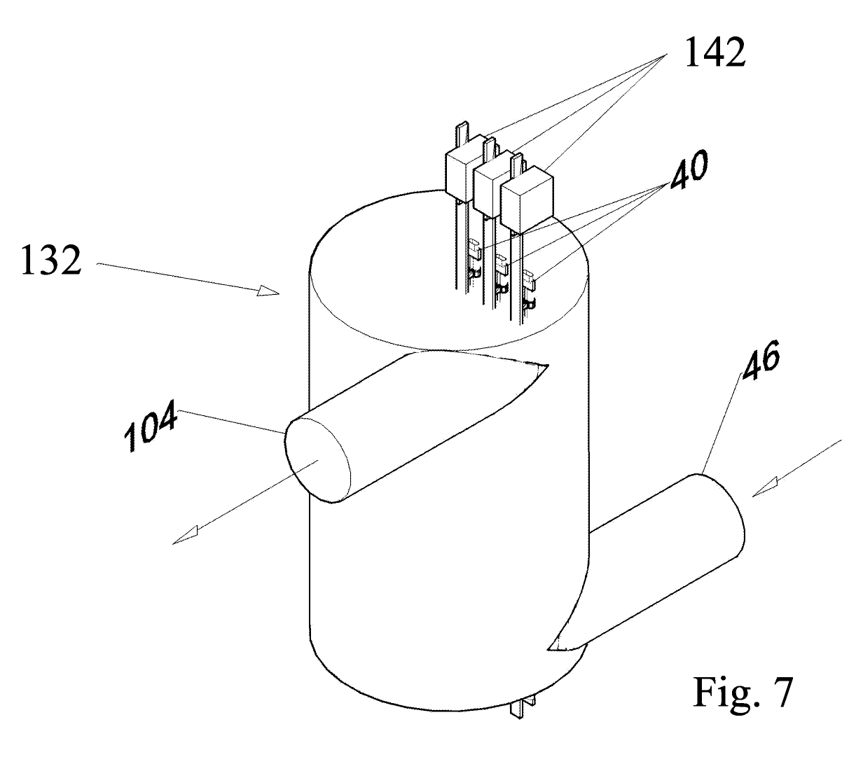

FIG. 7 (Sheet 7) illustrates a perspective view of a thermal infrared incinerator, in accordance with an embodiment of the present disclosure

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiment are often not depicted in order to facilitate a less obstructed view of these various embodiments of the present disclosure.

### 2. References

20 Hybrid heatset and coldset printing press, or “hybrid press”
22 Raw product, also referred to as “paper,” “web,” or “paper web”
24 Ink
26 Water solution
28 Splicer
30 Control system
34 Infra-red preheater, also referred to as a “preconditioner,” or “IR preheater”
36 Lamp box assembly, also referred to as a “lamp box pair”
38 Lamp box
40 Lamp bulbs
42 Lamp box fixture
44 Electric fan(s)
46 Air ducting
48 Blower
50 Main infrared heat enclosure, also referred to as “IR heat enclosure”
52 Glass plates
54 Temperature sensors
56 Airflow monitor
58 Web press
60 Web infeed
62 Rotary encoder, also known as a “pulse generator.”
64 Chill roll
66 Pulse train signal
68 Chill roll operational signal
70 Enclosing shroud, also referred to as a “shroud,” or “enclosure”
72 IR assembly
74 Shroud assembly
76 Exterior frame
78 Shroud enclosed IR box housing structure
80 Outer shroud assembly compartment
82 Injection blowers
84 Back side portals of the installed lamp boxes
86 Inner shroud assembly compartment
88 Upper air knife section of external compartment
90 Ambient Air
92 Lower air knife section of external compartment
94 Small holes or slits
96 Upper air knife
98 Lower air knife
100 Finished product
102 Exhaust blower
104 Vent to outdoors
106 Means for attachment
108 Main electrical enclosure
110 Chill roll
112 Hollow tubes
114 End plates
116 Hollow shafts
118 Outer end each hollow shaft
120 Reservoir
122 Chiller
124 Water pump
126 Chill rolls drive assembly
128 Air cooler
130 Former board
132 Former board blower
134 Blower electric drive
136 Chill rolls electric drive
138 Electrical infrared thermal incinerator
140 Electrical Contactor
142 Lamp bar assembly
148 Control system touch screen or keypad
150 Electric Supply

### DETAILED DESCRIPTION

The following description is not to be taken in a limiting sense, but is made merely for the purpose of describing the general principles of exemplary embodiments, many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

Further, all numbers expressing dimensions, physical characteristics, and so forth, used in the specification and claims are to be understood as being modified in all instances by the term “about”. Accordingly, unless indicated to the contrary, the numerical values set forth in the following specification and claims can vary depending upon the desired properties sought to be obtained by the practice of the invention. At the very least, and not as an attempt to limit the application of the doctrine of equivalents to the scope of the claims; each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 6.3, or 5.5 to 10, or 2.7 to 6.1.

For the purposes of promoting an understanding of the principles of the present invention, reference will now be made to the embodiments illustrated in the drawings and specific language will be used to describe the same.

Embodiments of the present description illustrate a process and apparatus for a hybrid heatset and coldset printing press (20), which may be a conversion from a coldset printing press, that has combination of machinery that comprise subsystems and sub assemblies that are controlled by a control system (30). The control system is necessary because timing and temperature of each of the subsystems and assemblies must be carefully coordinated. Through the control system (30) software may manages turning the drying system on and off, the temperature of chillers, the temperature of lights, and additional functions of the machinery. Some system components may not need to be controlled by the control system. The control system (30) may optionally take into account press speed and/or control press speed. Typically users will want to control their own press speed based on a review of the product. The control system (30) can be operated by touch screen or keypad operations (148).

Key advantages of the hybrid press, or the conversion of a coldset press to the hybrid press are that: the hybrid press produces mixed web easily; it allows the operator of the press to print on newspaper and gloss enamel paper with the same press and same ink, which means no retrofitting, blanket changes, roller changes, or no ink changes are involved; and it can use a economical heatset ink on heatset glossy paper. Once the apparatus has been installed on a coldset printing press, the hybrid printing press can deliver heatset jobs on the coldset printing press without the need for an additional heatset press.

Additionally, the hybrid printing press requires little space as it only occupies a 5′×5′ area, on, above, or to the side of the press. Compact and totally merged with the press, the system can be affixed to numerous used coldset presses and replace large and expensive dryers and chillers typically used with heatset presses at a fraction of the cost.

Referring now to FIG. 1, there is depicted an embodiment of a schematic flow chart representation of the process and apparatus for operation of the hybrid heatset and coldset printing press; not pictured are the control system operation, sensor and feedback circuits, as well as the printing press and other equipment used outside of the process and apparatus for operation of the hybrid heatset and coldset printing press (20). FIG. 2 is a schematic diagram of components of the apparatus herein described as a hybrid heatset and coldset printing press, or “hybrid press.” FIGS. 1 and 2 will be referred to through the following descriptions, where other figures are referred to they will be noted by number.

### Process and Apparatus for Operation of the Hybrid Heatset and Coldset Printing Press

The raw product (22) used in sheet fed or offset web printing, is paper, which comes to the printing facility in the form of rolls of paper for offset web printing or sheets of paper for sheet fed printing. Rolls of paper for web offset printing often weigh close to a thousand pounds and are sized to the width of the paper that unspools off of them. The paper roll is loaded onto a splicer (28), of which there are several types, which can splice the end of an unwound roll of paper, to a fully wound roll of paper, without interrupting, or slowing down the constant flow of paper through the printing process. Common full widths of paper are between 24 inches, to 40 inches. The rolls of paper come in a variety of thicknesses, as well as a variety of grades and qualities. Two main distinctions between types of paper are: coated and uncoated paper. Uncoated paper is commonly used in newspaper printing, which is also known as coldset printing. The coated type, is also known as heatset, and has a gloss finish, as opposed to the dull matte of newsprint.

A secondary product used in web printing (although just as necessary), is ink (24). There are many types of ink; three main types of inks are designed for coldset, heatset, or UV printing. An embodiment of the present description of hybrid printing press can use one ink to produce great quality heatset and coldset prints, which is a significant improvement in the arts. The process flow chart illustrated in FIG. 1 described herein, does not describe anything regarding said ink, other than the depiction of an offset press and system of using such a press, in which such ink is used. A third material not shown or mentioned other than here is a water solution (26) which is compatible with the ink, and used in the press, and process. The water solution (26) mixes with the ink and is placed as a layer of print across the faces of paper web (22) that flows though an offset printing press (58).

The product flow chart illustrated in FIG. 1, operating on the hybrid printing press (20) illustrated in FIG. 2 begins with a raw product (22) that is mounted onto a web splicer (28), to begin the process of unwinding and flowing throughout the hybrid printing press (20) until it becomes a finished product (100).

### Infrared Preheater

Once the raw product (22) is run through the splicer(s) it may be treated by an infrared preheater (34), also known as a preconditioner, or IR preheater. FIG. 3 illustrates an embodiment of an infrared preheater (34). Raw product (22) may flow between two (pair) or more lamp box assemblies (36) that warm the paper and remove its moisture. Moisture, depending on amount, can have an adverse effect on the printed product. The lamp boxes (38) may each be fitted with one, two, or three lamp bulbs (40). The lamp boxes (38) could be constructed for accommodating more than three bulbs each, although they would be more cumbersome to handle for maintenance purposes. Lamp boxes (38) are best suited to utilize three bulbs each for the sake of maximum three phase power efficiency.

The individual lamp boxes, and structures they fit into, have been designed with the concept of modularity, so as to easily interchange into the preconditioner (34), the main IR heat enclosure (50), or the electrical thermal infrared incinerator (138). Besides the lamp boxes, the preconditioner consists of a lamp box fixture (42) to mount the lamp boxes (38) into, or onto, to straddle the web as the paper flows between the secured lamp bulbs (40). Each lamp box (38), can also be fitted with one or more electric fans (44) mounted along its back side, with, or without additional shrouding; or with air ducting (46) from one or more blowers (48), or be enclosed in its own shroud with one or more blowers (48) supplying air that may flow from behind, and across the bulbs (40). This airflow performs two functions: (1) it keeps the rear of the bulbs cool so they don't overheat; and (2), it forces the heat radiating from the bulbs onto the paper. Alternatively, more expensive bulbs are available that can withstand higher temperatures without the need for cooling. The infrared preheater can also be constructed in a similar fashion to the main IR enclosure described more fully below.

Still referring to FIG. 3, glass plates (52) might be installed between the lamp bulbs (40), and the paper web (22), although this would reduce the efficiency of the process. The IR preheater process can be monitored with one or more temperature sensor(s) (54) that monitor the temperature of the paper web (22) after it has been preconditioned, which would provide feedback to the control system for adequate adjustment of the power output to the lamp bulbs (40). Optionally, additional temperature probes may monitor the electrical enclosures for overheating.

For maximum process efficiency, an airflow, air pressure, or vacuum monitor (56) can be used to gauge the air flow in the lamp box assemblies (36); this is highly recommended not only to determine the successful conditioning of the paper, but also as a safety function as the airflow is a key deterrent to combustion of the paper within the lamp box assembly (36). The lamp box assembly (36) might also be designed to allow adjustment of the distance, or air gap, between the lamp bulbs; between the bulbs and the paper; or side to in order to center the main IR heat box (50) over the printing web (22). This could be controlled manually, or automated such that it can be controlled by the control system (30). The purpose of using a preconditioner to heat and dry the paper while entering the web press (58) is to prevent blistering on the final product (100) caused by moisture trying to escape from under ink once the ink is quickly heated for drying in the main IR heat enclosure (50). This is particularly common where both sides of the paper are heavily coated with ink.

This preconditioning process should be carefully controlled by the control system (30) as variances in paper temperature and humidity are correlated to room temperature and humidity, all of which vary continually; and the entire system works by balancing these variables at high speeds to prevent loss of paper, use of ink, use of electricity, and quality of the final product.

### Web Infeed

A web infeed (60), which produces a constant tension on the web, may, or may not be used, or needed, depending on the printing press, or configuration. Other common printing devices and equipment which may be used in conjunction as part of this process, such as air turn bars, or air flow turns, are not shown or described. Such devices, and equipment may be redundant throughout the process as well, to produce many different configurations as desired.

### Rotary Encoder

Mechanically connected to the offset press (58), this rotary encoder (62), or pulse generator fulfills two functions. Its primary purpose, is to help synchronize the speed of the chill rolls (64) as precisely as possible, to the speed of the paper web (22) as it passes through the offset press (58). Although not mandatory for the hybrid press (20), the secondary purpose of the rotary encoder (62) is to greatly enhance the efficiency of the drying process. The chill rolls (64) could be driven mechanically off the press (58), or press drive line, which would eliminate the primary purpose of the rotary encoder (62) since its purpose is to coordinate the chill rolls spin speed with the speed of the paper coming through the press. The rotary encoder may be driven mechanically using one or more of one of the following: belts, chains, gears, or similar objects; directly, or in combination. The rotary encoder can also be driven off a press line drive shaft, folder, or any other press line equipment or device that provides an accurate web speed source.

The rotary encoder (62) sends a digitally encoded pulse train signal (66) to the control system (30) that assimilates, or represents, the press web speed. With the pulse train signal (66) the control system (30) is able to send a chill roll operational signal (68) to operationally match the speed of the chill rolls (64) with that of the web (22) speed. The rotary encoder (62) could also be a simple sensor, switch, or series of either, although they might not produce as fine of resolution as desired. Additionally; the rotary encoder (62), or sensor, might be driven off of, or monitor, the speed of the web paper (22) itself.

### Main Infrared Heat Enclosure

The main Infrared heat enclosure (50), or “IR heat enclosure” is the heart of the process. At its simplest the main IR heat enclosure simply comprises one or more infrared light bulbs (40), an enclosure to retain the heat produced by the IR bulbs (40) and an opening through which the web can pass as it is heated. The preferred embodiment of this invention utilizes the same lamp boxes (38) that have been described in the preconditioner (34). For reasons mentioned in the previous detail, the individual lamp boxes (38) may one or more lamp bulb but are preferentially constructed to house three lamp bulbs (40). The lamp boxes (38) are normally installed in pairs, one on either side of the web (22) that passes between them, to be most efficient.

When using coated paper, it has been found, that at least two sets (pairs) of lamp boxes (38) with three bulbs each (twelve bulbs total) are preferential for the curing process of the hybrid printing press (20). Printing on newspaper stock, requires far less heat and bulbs to obtain beneficial results. With higher speeds, more lamp box pairs are required to create the heat necessary to fully dry the applied ink, especially with heavier ink applications. Essentially, the lower the dwell time of the ink in the heater the hotter it needs to be.

Although the hybrid press (20) can operate without an enclosing shroud (70), utilizing one is far superior to not. In a preferred embodiment of the hybrid press (20): the shroud (70), the shroud enclosed IR box housing structure (78), lamp boxes (38), and lamps (40) comprise a shroud assembly (74). Two shroud assemblies basically mirror each other: as illustrated in FIG. 4, showing a skeletal view of the interior of the IR assembly (72), and allow the web (22) to flow vertically between them. The shroud assemblies (74) are supported by an exterior frame (76), as Illustrated in FIG. 5. The shroud assemblies (74) can be separated from each other to allow web (22) access (at idle), and then mated back together for production use. The means of separation can be either a tilt or a retract/extend mechanism. The preferred location for the IR heat enclosure (50), is mounted on top of a vertical (upward flow) press (58), although such an IR heat enclosure (50) can be mounted at an angle, horizontally, or directly beyond the press outlet. The lamp (40) and lamp box (38) alignment is typically perpendicular to the direction of paper flow, which is typically vertical, although the lamps (40) could be mounted at other than a right angle to the web flow direction, which is known as a herring bone design.

Although other configurations are possible, the preferred shroud assembly (74) internal construction consists of two compartments: an outer shroud assembly compartment (80), which receives ambient air (90) flow from injection blowers (82), and then optionally distributes it through multiple back side portals of the installed lamp boxes (84); and then optionally, through multiple small holes or slits behind the bulbs (94), and through upper (96) and lower air knives (98) and into the inner shroud assembly compartment (86); which comprises upper (88), and lower (92) air knife sections. The air (90), having flown through the upper (96) and lower (98) air knives, as well as through the multiple small holes or slits (94) positioned directly behind each lamp bulb (40), enter the inner shroud assembly compartment (86), where these air streams circulate air over the bulbs (40) and onto the paper web (22) as it moves through the IR heat enclosure (50) both cooling the bulbs and paper (22), while also preventing combustion of the web (22).

The air that flows through the lamp boxes (38) becomes heated by the lamp bulbs (40), and the air that flows through the upper (96) and lower air knives (98) operatively direct the heated air from the lamps to the upper knife section (88) of the inner shroud assembly enclosure (86) which collects this heated air turbulence, until it is drawn from upper knife section (88) of the inner shroud assembly enclosure (86) by exhaust blowers (102) which then vent the air (104) outside the building.

This superior enclosure design, may be constructed with sheet metal dividing the inner shroud assembly enclosure (86) from the outer shroud assembly enclosure (80); as well as providing structure for support of the placement of the lamp boxes (38), allowing them to be easily removed and replaced for access. Each shroud assembly (74) may be covered by sheet metal that forms a shroud (70) for the outer shroud assembly enclosure (80). The shroud (70) also forms the outer half of each upper (96) and lower (98) air knife. The inner half of the upper (96) and lower (98) air knife may be part of the shroud enclosed IR box housing structure (78). The sides of the inner (86) and outer shroud assembly enclosures (80) also form air passageways. The shroud assemblies (74) may have a means for attachment (106), such as: threaded nuts or means known to those of ordinary skill in the art mounted into them, at top and bottom; that operatively support the shroud assemblies (74).

Another embodiment (not shown) comprises using an angled iron frame that supports the lamp boxes (38), and uses the boxes and the frame as a large portion of the dividing structure between the chambers.

A potential design concept is to manipulate the air gap distance between lamp bulb (40) and web paper (22) (mentioned in the IR preheater details), to improve heating capability, and/or to prevent possible paper ignition. This gap distance manipulation would be controlled by the control system, dependent on process cycle timing, and by means of additional movement mechanisms.

The basic concept of the air blade system is that infrared bulbs (40) heat up quickly; air blowing through the tight chamber at a very high velocity prevents a build up of excess heat in the main IR heat enclosure (50), thereby preventing fire. Additionally, the increased pressure and velocity of oxygen pass-through prevent oxygen from catalyzing the chain reaction of combustion. The paper is also cooled through direct contact, although this effect is less important.

### Main IR Electrical Enclosure

A main electrical enclosure (108), houses most of the electrical power and control components to the hybrid press (20) process. Some of the not housed electrical power and control components, such as those integral to any separately manufactured chiller, are best left intact, or slightly modified to allow remote control. Common components used in this enclosure, are a main disconnect, fuse holders with fuses, circuit breakers, distribution blocks, control transformer, power contactors, relays, motor overload relays, lamp power controllers, current transformers, cooling fans, and the main computer processor. The most common processor likely used, is also known as a Programmable Logic Controller (PLC), or such industrial processor. Numerous cables are used to interconnect the main enclosure to all of the external process devices, and components. These flexible multi-conductor cables are of two main types, power, and control. Each cable is fitted with connectors to secure and pass into the enclosure with, as well as connectors on the external end of each cable, which allows a person to quickly connect, or disconnect them to and from their specific components. The main electrical enclosure (108) and various components of the hybrid press are all supplied with electricity (150).

### Chill Rolls

Chill rolls (110), as pictured in FIG. 6, are comprised of: hollow tubes (112) that have been fitted with end plates (114) and one or more hollow shafts (116) which may comprise inner bores to allow water to flow into and out of the tube. Use of a single hollow shaft (116) may provide for more structural strength and more ensured alignment of the roller (110). The shafts (116) may be mounted to pillow block bearings (not shown) secured to a frame (not shown) which may also support the main IR heat enclosure (50), or they may be secured to some other frame or structure which follows the heat application of the hybrid press (20). The hollow tube (112) would typically be made of aluminum or another material prone to swift heat transfer. The outer end of each hollow shaft (118) may be fitted with a rotary union, or other means for coupling, which allows a hose or tubing to be connected so that water can pass into and through the chill roll (110). Chill Rolls are typically used in pairs, and mounted perpendicular to the direction of paper web travel so as to maximize web surface area contact.

The purpose of each chill roll (110) is to swiftly exchange heat from the paper (22) to the chill roll (110); which, in turn, transfers that heat to water that is constantly flowing through each chill roll (110). The heated water flowing from the chill roll (110) returns to a reservoir (120), which contains a supply of water with a volume capable of meeting the needs of the hybrid press's (20) requirements. When operating the reservoir (120) is kept at a constant cold temperature by means of a chiller (122), and water is pumped with a water pump (124) back to the chill rolls (110), to remove more heat from the web (22). These water flows travel through hoses, pipes, and tubing that interconnect the various components. The chill rolls (110) need to rotate at as close to the same speed as the web (22) as possible, as previously mentioned in the discussion of the rotary encoder (62). One end (gear side) of each of these tubes, may have a gear, or sprocket mounted onto it's shaft (not pictured), so that the chill roll (110) can be driven with a belt, chain, wheel, or some other means, possibly even direct drive.

### Chill Rolls Drive Assembly

A chill rolls drive assembly (126), can be an electric motor, or servo, which is powered by an electric drive (136), or amplifier, which propels the chill rolls (110) based on the current web speed. The chill rolls drive assembly (126) can be fitted with a gear, sprocket or the like, and the assembly would include a mounting structure for the motor (not pictured), an adjustable motor base; and, or an idler; to be used with the drive belt, chain, wheel, or gearing. The mounting structure would normally be located on the main IR heat enclosure frame (74), and fairly close to the chill rolls (110). The chill rolls (110) are not mandatory for the hybrid press (20), although they are very beneficial to a quality product.

### Air Cooler

An air cooler (128) uses water from the chill system's reservoir (120) to cool the heated air that a former board blower (132) draws from the ambient air (90) to supply the former board (130). The former board blower (132) can be driven by an electric motor, or servo, which is powered by a blower electric drive (134). The chilled air from the air cooler (128) is then blown through small holes or slits (94) on the former board (130), preferably on its sides; thereby reducing friction on the former board (130) and cooling the paper. This process helps to set the ink and prevent pages from sticking together.

### Electrical Infrared Thermal Incinerator

Drying ink puts off a substantial amount of volatile organic compounds that are toxic and regulated by the Federal Clean Air Act. Most printing presses in the US are required to treat their exhaust with a thermal incinerator. Current thermal incinerators are made of gas and are large and occupy similarly large amounts of space. FIG. 7 illustrates an electrically powered infrared thermal incinerator (138) of a much smaller design. The electrically powered infrared thermal incinerator (138) accepts exhaust from the printing press from air ducting (46) and utilizes one or more infrared lamp bulbs (40) which may be in a lamp bar assembly (142) to heat the exhaust up to 1600 degrees Fahrenheit and incinerate any particulate matter and the toxic vapors given off by the ink when the ink is dried by the infrared heaters and chill rolls before the exhaust from the printing press is vented to the outdoors (104). The electrically powered infrared thermal incinerator (138) only requires a space as small as 5′×5′ area on, above, or to the side of the press.

Information as herein shown and described in detail is fully capable of attaining the above-described object of the present disclosure, the presently preferred embodiment of the present disclosure; and is, thus, representative of the subject matter; which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed is:

1. A hybrid printing press capable of printing both heatset and coldset printing with the same ink, comprising:
a control system;
a infrared lamp bulb; and
a main infrared heat enclosure.

2. The hybrid printing press of claim 1, wherein said ink is heatset ink.

3. The hybrid printing press of claim 1, wherein said main infrared heat enclosure may occupy a floor area of less than 5 feet by 5 feet.

4. The hybrid printing press of claim 1, wherein said main infrared heat enclosure is located directly on top of a press.

5. The hybrid printing press of claim 1, wherein said main infrared heat enclosure further comprises:
a blower;
an air knife;
a shroud assembly, wherein said shroud assembly comprises an outer shroud compartment and an inner shroud compartment; and
wherein one or more of said blowers blows air into said outer shroud compartment and through one or more of said air knives and then out an inner shroud compartment.

6. The hybrid printing press of claim 5, wherein said shroud assembly is paired with another shroud assembly such that the pair of shroud assemblies are on either side of a paper, and said pair of shroud assemblies are capable of opening and closing for ease of access to the inner shroud compartment.

7. The hybrid printing press of claim 1, further comprising a modular lamp box.

8. The hybrid printing press of claim 7, wherein said modular lamp box has openings to facilitate the flow of air.

9. The hybrid printing press of claim 1, wherein said control system comprises a main disconnect.

10. The hybrid printing press of claim 1, wherein said control system comprises:
a heat sensor and temperature control for an infrared preheater;
a sensor to determine a pulse train signal from a rotary encoder;
a heat sensor and temperature control for a main infrared heat enclosure;
a heat sensor and temperature control for a chill roller.

11. The hybrid printing press of claim 10, wherein a touch screen or a keypad can operate said control system.

12. The hybrid printing press of claim 1, further comprising: an infrared preheater.

13. The hybrid printing press of claim 1, further comprising:
a chill roller;
a chill roller drive assembly;
a reservoir;
a chiller;
an air chiller; and
a former board.

14. The hybrid printing press of claim 1, further comprising: an electrical infrared thermal incinerator.

15. The hybrid printing press of claim 14, wherein said electrical infrared thermal incinerator occupies a floor area of less than 5 feet by 5 feet.
